(19) United States
(12) Patent Application Publication
(10) Pub. No.: US 2022/0351102 A1
(43) Pub. Date: Nov. 3, 2022

(54) COMMUNITY MONITORING SYSTEM AND METHOD TO OPERATE SAME

(71) Applicants: Siddharth Banerjee, BENGALURU (IN); Krithika Radhakrishnan, Vishakapatanam (IN); Viswanath Subramanian, BANGALORE (IN); Sriram Padmanabhan, THRISSUR (IN)

(72) Inventors: Siddharth Banerjee, BENGALURU (IN); Krithika Radhakrishnan, Vishakapatanam (IN); Viswanath Subramanian, BANGALORE (IN); Sriram Padmanabhan, THRISSUR (IN)

(21) Appl. No.: 16/491,817

(22) PCT Filed: Aug. 20, 2019
(86) PCT No.: PCT/IB2019/056993

§ 371 Date: Sep. 6, 2019

(30) Foreign Application Priority Data
Jul. 5, 2019 (IN) 201941027093

(51) Int. Cl. G06Q 10/06

(52) U.S. Cl. CPC G06Q 10/06311

(57) ABSTRACT

A system for community monitoring is disclosed. The system includes a community processing subsystem. The community processing subsystem includes an entity control module, configured to control each of plurality of tasks corresponding to one of a plurality of entities. The community processing subsystem also includes a task monitoring module, configured to monitor each of the plurality of tasks corresponding to one of the plurality of entities by entity associated techniques. The community processing subsystem also includes an information exchange module, configured to exchange information within the plurality of entities. A community memory subsystem is configured to store details regarding monitored plurality of tasks corresponding to one of the plurality of entities in real time. Present disclosure enables proper monitoring of every possible entity in a society through a common platform.

This International Application claims priority from a complete patent application filed in India having Patent Application No. 201941027093, filed on Jul. 05, 2019 and PCT Application filed with the World International Property Organisation (WIPO) having Patent Application No. PCT/IB2019/056993, filed on Aug. 20, 2019 titled “COMMUNITY MONITORING SYSTEM AND METHOD TO OPERATE THE SAME”

### FIELD OF INVENTION

Embodiments of a present disclosure relates to a monitoring system, and more particularly to a community monitoring system and a method to operate the same.

### BACKGROUND

With the progress of society and the deepening of urbanization, community management in all together has become very important. Here, community is a small or large social unit (a group of living things) that share a small geographical location or place together. Along with sharing, community dwellers have to maintain the well-being of the geographic location or place.

At one instance, many entities like parking management system, water management system, surveillance system and the like are in use. All the entities mentioned above are to be controlled separately independent of each other. Independent monitoring techniques are used for each of the entities.

In conventional approach, all controllable entities of a community like parking management, community common-space management, water management and the like have separate system to control and monitor. Manually one has to check two or more separate entity system to make a considerable conclusion in any decision making in relation to the community. More effective way would be to find an automatic, all in one solution, whereby all-important community entities are controlled and monitored together. Effectiveness may be increased by providing communication facilities and synchronization facilities in between the entities.

Hence, there is a need for an improved community monitoring system and a method to operate the same and therefore address the aforementioned issues.

### BRIEF DESCRIPTION

In accordance with one embodiment of the disclosure, a system for community monitoring is provided. The system includes a community processing subsystem. The community processing subsystem includes an entity control module. The entity control module is configured to control each of plurality of tasks corresponding to one of a plurality of entities.

The community processing subsystem also includes a task monitoring module. The task monitoring module is operatively coupled to the entity control module. The task monitoring module is configured to monitor each of the plurality of tasks corresponding to one of the plurality of entities by entity associated techniques.

The community processing subsystem also includes an information exchange module. The information exchange module is operatively to the entity control module. The information exchange module is configured to exchange information within the plurality of entities.

A community memory subsystem is operatively coupled to a community processing subsystem. The community memory subsystem is configured to store details regarding monitored plurality of tasks corresponding to one of the plurality of entities in real time.

In accordance with one embodiment of the disclosure, a method for monitoring plurality of entities in relation to a community is provided. The method includes registering a plurality of users associated with the community. The method also includes controlling each of plurality of tasks corresponding to one of the plurality of entities.

The method also includes monitoring each of the plurality of tasks corresponding to one of the plurality of entities by entity associated techniques. The method also includes exchanging information within the plurality of entities. The method also includes notifying monitored result to each of the plurality of users associated with the community.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for community monitoring in accordance with an embodiment of the present disclosure;

FIG. 2 is a schematic representation of an exemplary embodiment representing the system for community monitoring of FIG. 1 in accordance of an embodiment of the present disclosure;

FIG. 3 is a block diagram of a computer or a server in accordance with an embodiment of the present disclosure; and

FIG. 4 is a flowchart representing the steps of a method for monitoring plurality of entities in relation to a community in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises. . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for community monitoring. The system includes a community processing subsystem. The community processing subsystem includes an entity control module. The entity control module is configured to control each of plurality of tasks corresponding to one of a plurality of entities.

The community processing subsystem also includes a task monitoring module. The task monitoring module is operatively coupled to the entity control module. The task monitoring module is configured to monitor each of the plurality of tasks corresponding to one of the plurality of entities by entity associated techniques.

The community processing subsystem also includes an information exchange module. The information exchange module is operatively to the entity control module. The information exchange module is configured to exchange information within the plurality of entities.

A community memory subsystem is operatively coupled to a community processing subsystem. The community memory subsystem is configured to store details regarding monitored plurality of tasks corresponding to one of the plurality of entities in real time.

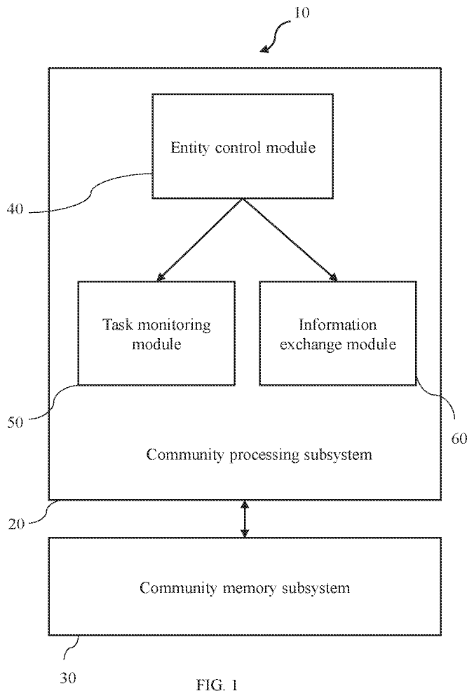

FIG. 1 is a block diagram representation a system for community monitoring 10 in accordance with an embodiment of the present disclosure. As used herein, the term “community” refers to a group of people living in the same place or having a particular characteristic in common. As used herein, the term “monitoring” refers to observing and checking the progress or quality of (something) over a period of time just providing a systematic review.

In one specific embodiment, the community monitoring 10 is point to point care for each of the plurality of entities. In such embodiment, the plurality of entities comprises at least one of parking management of the community, surveillance management of the community, entry and exit management of the community, water management of the community and common space management of the community.

The system 10 includes a community processing subsystem 20. The community processing subsystem 20 further includes a community registration module. The community registration module is configured to register a plurality of users associated with a community.

In one exemplary embodiment, the plurality of users comprises residents of the community or workers associated with community. In such embodiment, for accessing the system 10, the residents of the community first register's through the community registration module.

The community processing subsystem 20 also includes an entity control module 40. The entity control module 40 is configured to control each of plurality of tasks corresponding to one of the plurality of entities.

Here, in one embodiment, the plurality of tasks refers to specific regulating features in relation to plurality of entities. In one specific example, for parking management of the community tasks may be to detect empty two-wheeler parking space for guest, detect empty four-wheeler parking space for guest, detect usage duration time of a parking space and the like. In another specific example, for water management of the community tasks may be to detect the level of water during peak usage hours, detect the level of water usage during festivals, detect the water pressure during a particular time period and the like.

The community processing subsystem 20 also includes a task monitoring module 50. The task monitoring module 50 is operatively coupled to the entity control module 40. The task monitoring module 50 is configured to monitor each of the plurality of tasks corresponding to one of the plurality of entities by entity associated techniques.

Here, in one embodiment, the entity associated techniques refers to specific task associated techniques. In one exemplary embodiment, the associated technique may include at least one of an artificial intelligence technique and a machine learning technique. As used herein, the term “artificial intelligence” sometimes called machine intelligence, is an intelligence demonstrated by machines, in contrast to the natural intelligence displayed by humans and other animals, such as visual perception, speech recognition, decision-making, and translation between languages. As used herein, “machine learning” refers to an application of artificial intelligence (AI) that provides systems the ability to automatically learn and improve from experience without being explicitly programmed.

For example, in above stated specific example of parking management of the community an image capturing device may analyse the empty and filled spaces of the parking lot. Furthermore, in such embodiment, sensors may be enabled also to understand the parking lot condition. In such embodiment, the image capturing device may be a camera such swivel camera, dome camera and the like.

In one exemplary embodiment, the system 10 through image capturing device identifies the unlawful usage of parking space. Here, the system 10 notifies the owner of the parking space through various alert mechanism about the unlawful usage. The owner of the parking space may confirm the unlawful usage, through the captured image from the surveillance image capturing device.

In such exemplary embodiment, the system 10 may detect the vehicle owner of the unlawfully parked vehicle through the number plate. The system 10 may use a pre-defined database to detect the owner of the unlawfully parked vehicle. Simultaneously, the system 10 also notifies the vehicle owner through a notification module.

The community processing subsystem 20 also includes an information exchange module 60. The information exchange module 60 is operatively to the entity control module 40. The information exchange module 60 is configured to exchange information within the plurality of entities.

In continuation to the above stated parking management exemplary embodiment, the surveillance management entity in real time exchange information with parking management entity of the system 10. Here, proper synchronization of information is being enabled by the stated module 60.

The community processing subsystem 20 further includes the notification module. The notification module is operatively coupled to the task monitoring module 50. The notification module is configured to notify monitored result to each of the plurality of users associated with the community. In one embodiment, the notification may comprise at least one of text message, call, sound alert and the like.

A community memory subsystem 30 is operatively coupled to a community processing subsystem 20. In one embodiment, the community memory subsystem 30 is configured to store details regarding monitored plurality of tasks corresponding to one of the plurality of entities in real time.

In one embodiment, the community memory subsystem 30 is located on a blockchain platform. As used herein, the term “blockchain platform” refers to a decentralized, distributed and public digital ledger that is used to record transactions across many computers so that any involved record cannot be altered retroactively, without the alteration of all subsequent blocks.

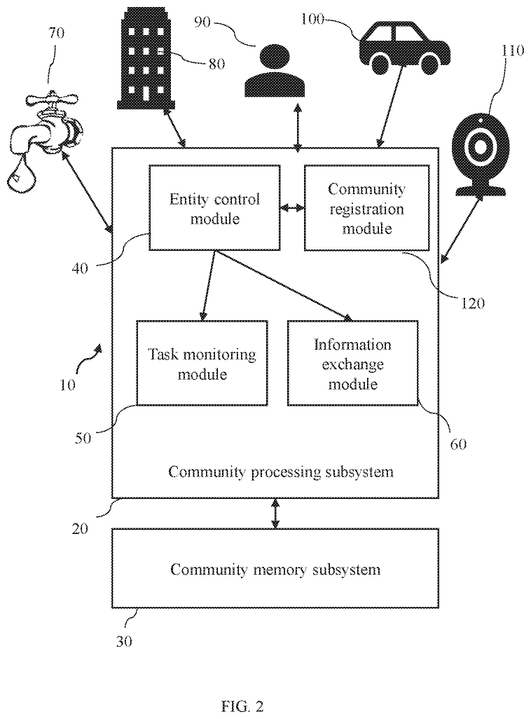

FIG. 2 is a schematic representation of an exemplary embodiment representing the system for community monitoring 10 of FIG. 1 in accordance of an embodiment of the present disclosure. In one example, a person X 90 uses the system 10 to keep track or monitor the various everyday needed entity in a society.

The person X 90 registers through a community registration module 120. The system 10 provides the control of every task corresponding to one of a plurality of entities through an entity control module 40. In exemplary situation, the system 10 provides control of entry and exit for a building 80, control for parking management of vehicles 100, control for the water management 70 and surveillance for a building 110.

Here, the system 10 provides a task monitoring module 50 operatively coupled to the entity control module 40. In above stated situation, the system 10 monitors through surveillance cameras for the entry and exit of the stated building gate. The building entry and exit management 80 may be further monitored by relay-controlled gates, boom barriers and the like.

The surveillance cameras help in surveillance of the building 110 along with that also passes information to the building entry and exit management 80 entity for proper checking. Here, an information exchange module 60 is being used for passing information within the entities.

Furthermore, in above stated exemplary situation, the surveillance camera 110 in the parking lot to enable the person X 90 to get notification related to empty or filled parking lot. The person X 90 may be notified by a parking management entity 100 about the status also. The parking management entity 100 may use various sensors to understand the condition of the parking entity.

It would be appreciated by the person skilled in the art, that all entities described in the above example would use corresponding entity associated techniques. Such as the parking management entity 100 may use sensor and light indicators; surveillance management 120 may use various image capturing devices; the water management entity 70 may use ultrasonic level sensing instruments; and the like. All such sensors inputs may be controlled by the task monitoring module 50.

Furthermore, in some specific embodiment, some entity may provide alternate option for linking to third party systems. For example, the water management entity may enable the person X 90 an option for payment of water bill through a third-party payment link representative of a payment network. Likewise, for another example, an integrated intercom entity enables calling features in association with third-party applications representative of a communication network.

The information exchange module 60 may enable proper interaction of monitored information between two or more associated entity. And thereby, in above stated specific exemplary embodiment, the needed condition is notified to person to person X 90.

The entity control module 40, the task monitoring module 50 and the information exchange module 60 in FIG. 2 is substantially equivalent to the entity control module 40, the task monitoring module 50 and the information exchange module 60 of FIG. 1.

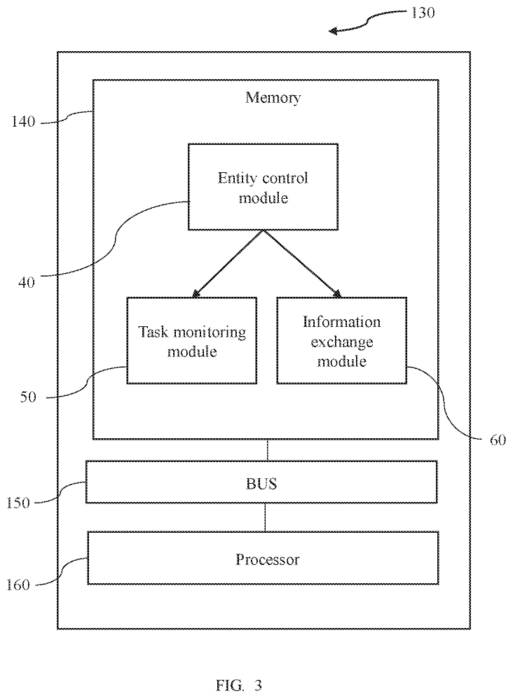

FIG. 3 is a block diagram of a computer or a server 130 in accordance with an embodiment of the present disclosure. The server 130 includes processor(s) 160, and memory 140 coupled to the processor(s) 160.

The processor(s) 160, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 140 includes a plurality of modules stored in the form of executable program which instructs the processor 160 to perform the method steps illustrated in FIG. 1. The memory 140 has following modules: the entity control module 40, the task monitoring module 50 and the information exchange module 60.

The entity control module 40 is configured to control each of plurality of tasks corresponding to one of a plurality of entities. The task monitoring module 50 is configured to monitor each of the plurality of tasks corresponding to one of the plurality of entities by entity associated techniques. The information exchange module 60 is configured to exchange information within the plurality of entities.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 160.

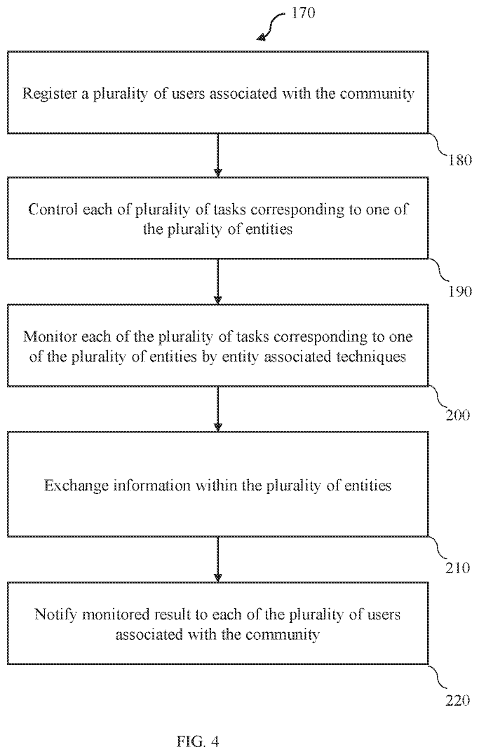

FIG. 4 is a flowchart representing the steps of a method for monitoring plurality of entities in relation to a community 170 in accordance with an embodiment of the present disclosure. The method 170 includes registering a plurality of users associated with the community in step 180.

In one embodiment, registering the plurality of users associated with the community includes registering the plurality of users associated with the community by a registration module. In another embodiment, registering the plurality of users associated with the community includes registering the plurality of users comprising residents of the community or workers associated with community.

The method 170 also includes controlling each of plurality of tasks corresponding to one of the plurality of entities in step 190. In one embodiment, controlling each of the plurality of tasks corresponding to one of the plurality of entities includes controlling each of the plurality of tasks corresponding to one of the plurality of entities by an entity control module.

In another embodiment, controlling each of the plurality of tasks corresponding to one of the plurality of entities includes controlling each of the plurality of tasks corresponding to one of the plurality of entities comprising at least one of parking management of the community, surveillance management of the community, entry and exit management of the community, water management of the community and common space management of the community.

The method 170 also includes monitoring of the plurality of tasks corresponding to one of the plurality of entities by entity associated techniques in step 200. In one embodiment, monitoring of the plurality of tasks corresponding to one of the plurality of entities by the entity associated techniques includes monitoring of the plurality of tasks corresponding to one of the plurality of entities by a task monitoring module. In one exemplary embodiment, the associated technique may include at least one of an artificial intelligence technique and a machine learning technique.

The method 170 also includes exchanging information within the plurality of entities by step 210. In one embodiment, exchanging the information within the plurality of entities includes exchanging the information within the plurality of entities by an information exchange module.

The method 170 also includes notifying monitored result to each of the plurality of users associated with the community in step 220. In one embodiment, notifying the monitored result to each of the plurality of users associated with the community includes notifying the monitored result to each of the plurality of users associated with the community by a notification module.

The method 170 further comprises storing details regarding monitored plurality of tasks corresponding to one of the plurality of entities in real time. In one embodiment, storing the details regarding monitored plurality of tasks corresponding to one of the plurality of entities in real time includes storing the details regarding monitored plurality of tasks corresponding to one of the plurality of entities by a community memory subsystem.

Present disclosure of a community monitoring system enables monitoring of every possible entity in a society through a common platform. All in one solution provides user-friendly system for all age group people. Manual checking of every entity is completely removed by the usage of present disclosed system.

Every entity uses its own associated techniques to find the monitored output correspondingly. The system further provides synchronization of information within each of the entities for better working. All such information exchange happens in real time, thereby by removing any lag in monitoring the entities. Moreover, as the system is stored on a block chain platform, extra security is provided.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for community monitoring, comprising:
a community processing subsystem, comprising:
an entity control module configured to control each of plurality of tasks corresponding to one of a plurality of entities;
a task monitoring module operatively coupled to the entity control module, and configured to monitor each of the plurality of tasks corresponding to one of the plurality of entities by entity associated techniques;
an information exchange module operatively coupled to the entity control module, and configured to exchange information within the plurality of entities; and
a community memory subsystem operatively coupled to a community processing subsystem and configured to store details regarding monitored plurality of tasks corresponding to one of the plurality of entities in real time.

2. The system as claimed in claim 1, further comprises a community registration module operatively coupled with the entity control module and configured to registered a plurality of users associated with a community.

3. The system as claimed in claim 1, further comprises a notification module operatively coupled to the task monitoring module, and configured to notify monitored result to each of the plurality of users associated with the community.

4. The system as claimed in claim 1, wherein the plurality of entities comprises at least one of parking management of the community, surveillance management of the community, entry and exit management of the community, water management of the community and common space management of the community.

5. A method for monitoring plurality of entities in relation to a community, comprising:
registering, by a community registration module, a plurality of users associated with the community;
controlling, by an entity control module, each of plurality of tasks corresponding to one of the plurality of entities;
monitoring, by a task monitoring module, each of the plurality of tasks corresponding to one of the plurality of entities by entity associated techniques;
exchanging, by an information exchange module, information within the plurality of entities; and
notifying, by a notification module, monitored result to each of the plurality of users associated with the community.

6. The method as claimed in claim 5, monitoring, by the task monitoring module, the plurality of entities comprises at least one of parking management of the community, surveillance management of the community, entry and exit management of the community, water management of the community and common space management of the community.

7. The method as claimed in claim 5, further comprises storing, by a community memory subsystem, details regarding monitored plurality of tasks corresponding to one of the plurality of entities in real time.
